(19) United States
(12) Patent Application Publication
(10) Pub. No.: US 2009/0265484 A1
(43) Pub. Date: Oct. 22, 2009

(54) METHOD FOR ENHANCING USB TRANSMISSION RATE

(75) Inventors: Cheng-Lung Tsai, Hsinchu (TW); Ting-Chun Wang, Hsinchu (TW); Yue-Lang Tang, Hsinchu (TW)

Correspondence Address: VIRTUAL LAW PARTNERS LLP, P.O. BOX 1329, MOUNTAIN VIEW, CA, 94042, US

(73) Assignee: RALINK TECHNOLOGY CORP., Hsinchu (TW)

(21) Appl. No.: 12/339,754

(22) Filed: Dec. 19, 2008

(30) Foreign Application Priority Data
Apr. 21, 2008 (TW) 097114437

(51) Int. Cl. G06F 3/00

(52) U.S. Cl. 710/33

(57) ABSTRACT

A method for enhancing USB transmission rate is disclosed. The method produces a second packet before receiving a callback signal corresponding to a first packet, thereby reducing the waiting time for receiving the callback signal and thus enhancing USB transmission rate.

### CROSS-REFERENCE TO RELATED APPLICATIONS

This application claims benefit of foreign priority under 35 USC §119, to Taiwan Patent Application No. 09711437, filed on Apr. 21, 2008, which is incorporated herein by reference.

### BACKGROUND OF THE INVENTION

1. Field of the Invention

This invention generally relates to a transmission method of Universal Serial Bus (USB), and more specifically, to a method for enhancing the USB transmission rate.

2. Description of Related Art

Universal Serial Bus (USB) is a widely adopted computer interface in the modern computer industry. USB provides a high-speed transmission between the computer and an external device. USB is also capable of providing proper power to the external device, thereby enabling some devices, such as a printer, a wireless network card, a portable CD, an optical mouse, etc., to be connected to the computer for user's demands.

USB has the following four basic modes of data transmission: control transmission mode, interruption transmission mode, bulk transmission mode, and isochronous transmission mode. However, the control mechanism of current USB is not ideal yet in the bulk transmission mode, thereby causing unsatisfying efficiency on bulk transmission. Especially, after each bulk transmission is completed and before a subsequent bulk transmission begins, USB has to wait to receive a callback signal transmitted from the recipient as a confirmation of receiving. During the waiting period for the callback signal, USB is in an idle state incapable of processing the subsequent bulk transmission. This situation exists especially in the established Macintosh operating system, i.e. Mac OS. In Mac OS, the waiting period for the callback signal lasts for 1 ms, such that the transmission rate of USB applied therein is unable to satisfy the high demand nowadays.

Please refer to FIG. 1, which is a time sequence diagram illustrating a conventional process of USB bulk transmission. As shown in FIG. 1, the horizontal axis shows the time, and the vertical axis shows the transmission in a downward sequence. According to the conventional USB bulk transmission mode, before processing each bulk transmission, the packet to be transmitted is prepared and then transmitted. After that, a callback signal has to be received before preparing the succeeding packet. In FIG. 1, the packet preparation period PP indicates a period of time for preparing a packet, the packet transmission period BO indicates a period of time for transmitting the packet, the waiting period Wt indicates a period of time for waiting for a callback signal after transmitting the packet, and the receiving callback period CA indicates a period for receiving the callback signal. As shown in FIG. 1, only after a waiting period Wt, the callback signal is received, and only after the callback signal is received, the next packet is prepared. Since the conventional technique involves a plurality of waiting periods, the USB transmission rate can not be efficiently enhanced.

Hence, it is a highly urgent in the industry to provide a technique capable of effectively solving the drawbacks of the conventional method as mentioned above.

### SUMMARY OF THE INVENTION

In view of the disadvantages of the conventional method mentioned above, the present invention provides a method for enhancing Universal Serial Bus (USB) transmission rate. The method includes generating a first packet; transmitting the first packet; receiving a first callback signal, wherein the first callback signal corresponds to the first packet; generating a second packet before receiving the first callback signal; and transmitting the second packet.

In addition, the present invention provides a method for enhancing USB transmission rate including the steps of: receiving a first plurality of packets, wherein each of the first plurality of packets comprises a header and a data string; generating a first integrated packet according the first plurality of packets, wherein the first integrated packet includes all data strings of the first plurality of packets but not any header of the plurality of packets; transmitting the first integrated packet; receiving a first callback signal, wherein the first callback signal corresponds to the first integrated packet; receiving a second plurality of packets, wherein each of the second plurality of packets comprises a header and a data string; generating a second integrated packet according to the second plurality of packets before receiving the first callback signal, wherein the second integrated packet includes all data strings of the second plurality of packets but not any header of the another plurality of packets; and transmitting the second integrated packet.

### BRIEF DESCRIPTION OF DRAWINGS

The present invention can be more fully understood by reading the following detailed description of the preferred embodiments, with reference made to the accompanying drawings, wherein:

FIG. 1 is a time sequence diagram illustrating process of conventional USB bulk transmission;

FIG. 2 is a time sequence diagram illustrating the USB bulk transmission according to the first embodiment of the present invention;

FIG. 3 is a time sequence diagram illustrating the USB bulk transmission according to the second embodiment of the present invention;

FIG. 4 is a diagram illustrating a packet;

FIG. 5 is a diagram illustrating an integrated packet;

FIG. 6 is a time sequence diagram illustrating the USB bulk transmission according to the third embodiment of the present invention; and

FIG. 7 is a time sequence diagram illustrating the USB bulk transmission according to the fourth embodiment of the present invention.

### DETAILED DESCRIPTION OF PREFERRED EMBODIMENTS

The following illustrative embodiments are provided to illustrate the present invention. For those skilled in the art, these and other advantages and effects are apparent after reading the description. The present invention can also be performed or applied by other different embodiments. The details of the description may be on the basis of different points and applications, and numerous modifications and variations can be devised without departing from the spirit of the present invention.

Furthermore, the following illustrations are simplified diagrams for depicting the basic ideas of the present invention. Therefore, all figures depict components simply related to the present invention, while number, shape, and size of the components are not illustrated to scale. In practical application, type and number of each component and ratio are variables, also layout of components can be more complicated.

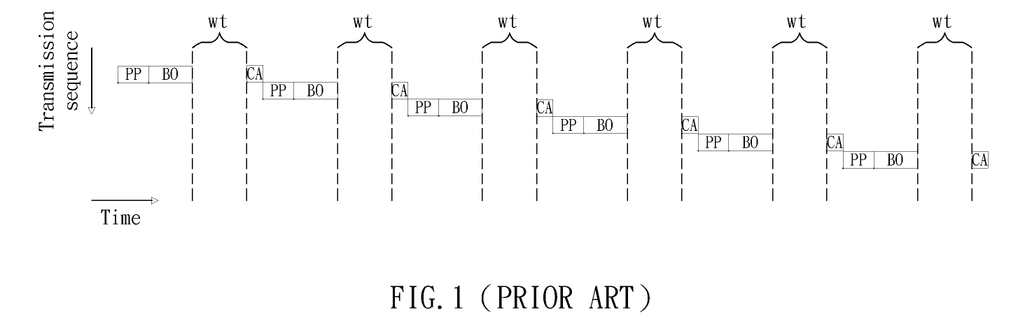

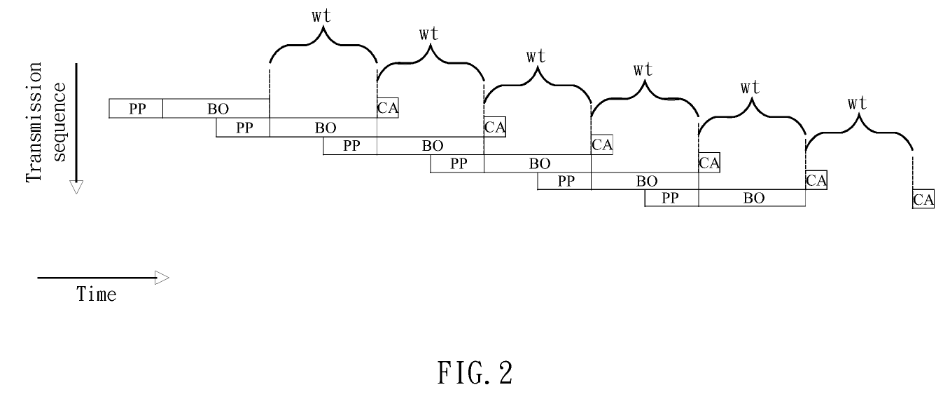

The present invention provides a method capable of continuously transmitting packet during waiting periods for callback signals. Please refer to FIG. 2, which is a time sequence diagram illustrating the USB bulk transmission according to the first embodiment of the present invention. Similar to FIG. 1, the packet preparation period PP in FIG. 2 indicates a period of time for preparing a packet, the packet transmission period BO indicates a period of time for transmitting the packet, the waiting period Wt indicates a period of time for waiting for receiving a callback signal after transmitting the packet, and the receiving callback period CA indicates a period for receiving the callback signal. In the present embodiment, after each process of transmitting a packet, the process of transmitting the next packet begins immediately after the completion of the process of transmitting the packet. For instance, in accordance to the completion of the process of transmitting the first packet, the process of transmitting the second packet immediately begins. Likewise, the process of transmitting a third packet begins immediately correspondingly to the completion of the process of transmitting the second packet, and so on. Therefore, as shown in FIG. 2, the end of each packet transmission period BO falls at same point of time as the beginning of the succeeding packet transmission period BO. In addition, as soon as a packet is generated, the generated packet is transmitted out instantly.

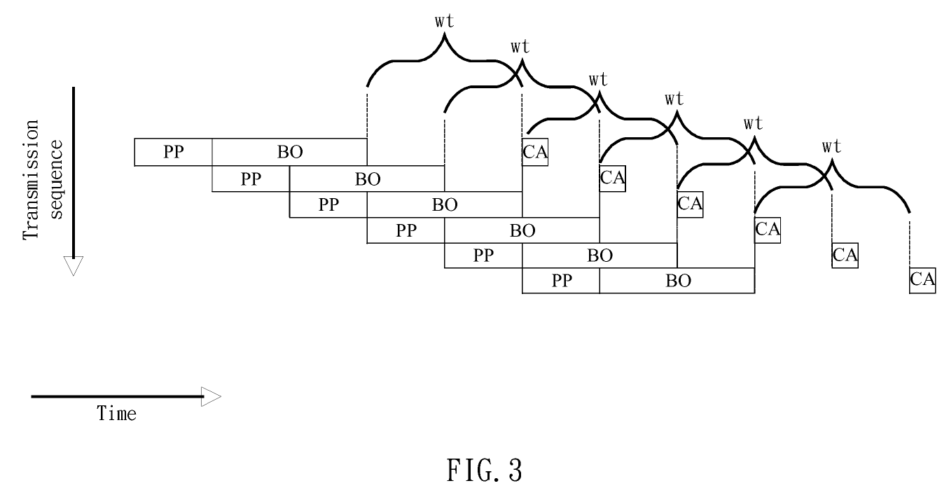

Please refer to FIG. 3, which is a time sequence diagram illustrating the USB bulk transmission of a second embodiment of method according to the present invention. The present embodiment differs from the first embodiment in that each time when process of generating a packet is completed, i.e. in response to the completion of the process of generating the packet, process of generating a succeeding packet begins immediately. Therefore, compared with the first embodiment, the present embodiment enhances data transmission rate more efficiently. In addition, as described in the first embodiment, as soon as a packet is generated, the generated packet is transmitted out instantly in the present embodiment.

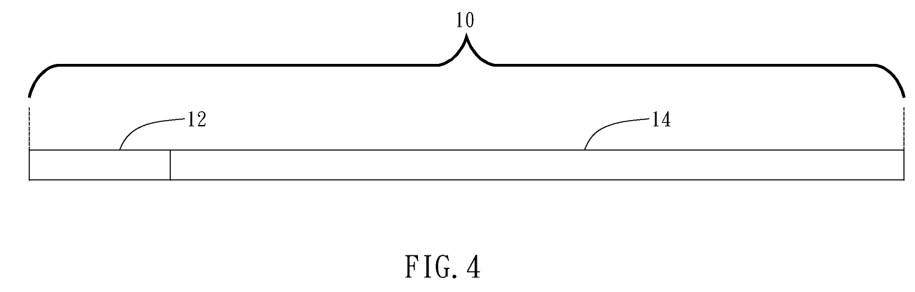

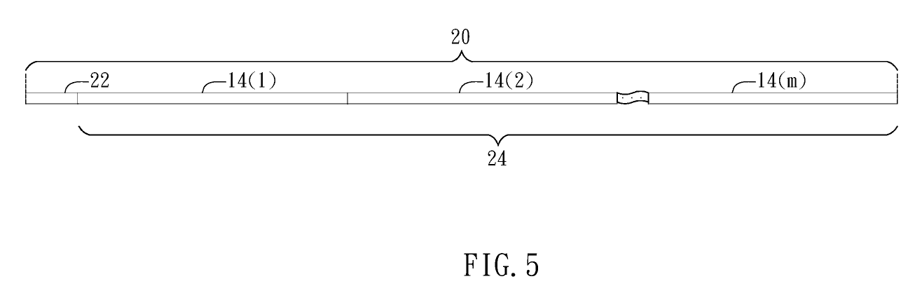

To further efficiently enhance Universal Serial Bus transmission rate, in other embodiments, the method further includes a step of integrating a plurality of packets into an integrated packet before the transmission process. Please refer to FIGS. 4 and 5. FIG. 4 is a diagram illustrating a common packet 10, and FIG. 5 is a diagram illustrating a integrated packet 20. Each packet 10 includes a header 12 and a data string 14, wherein the header 10 keeps records of data related to the packet 10 such as checksum code, data type, provider code (or manufacturer code), etc. The data string 14 includes general data. Each integrated packet 20 includes an integrated header 22 and an integrated data string 24, wherein the integrated data string 24 includes data strings 14 of a plurality of packets 10, as shown in FIG. 4, including m data strings 14(1), 14(2), . . . , and 14(m). The integrated header 22 of the integrated packet 20 keeps records of data related to the integrated packet 20, such as abovementioned checksum code, data type, provider code (or manufacturer code), etc. Accordingly, the integrated packet 20 includes m data strings of packets 14(1), 14(2), . . . , and 14(m) but only one integrated header 22. Therefore, total data amount of the integrated packet 20 is less than total data amount of m packets. Consequently, by means of integrating a plurality of packets into a single integrated packet before the plurality of packets are transmitted, Universal Serial Bus transmission rate is thus enhanced.

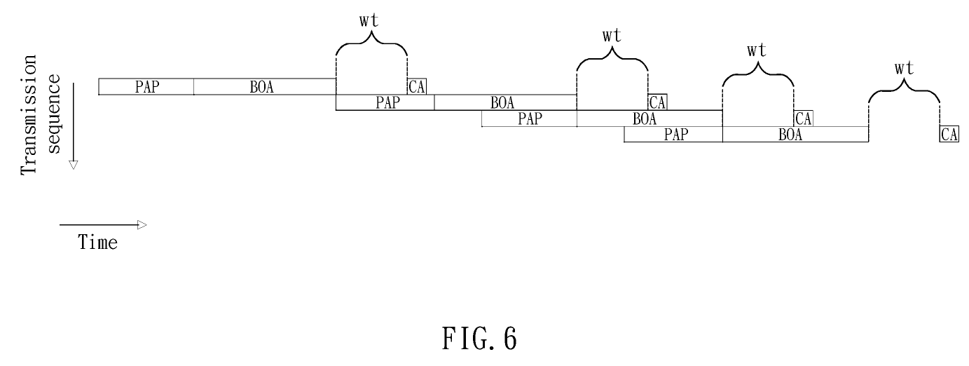

Please refer to FIG. 6, which is time sequence diagram illustrating the USB bulk transmission according the third embodiment of to the present invention. As shown in FIG. 6, the present embodiment is mostly similar to but differs from the first embodiment in that during a period of time between two adjacent waiting periods, it is an integrated packet 20 transmitted but not simply a single packet. As shown in FIG. 6, integrated packet preparation period PAP indicates a period of time for integrating an integrated packet, integrated packet transmission period BOA indicates a period of time for transmitting the integrated packet, waiting period Wt indicates a period of time for waiting for a callback signal after completing process of transmitting the integrated packet, and receiving callback period CA indicates a period of time for receiving the callback signal.

In the present embodiment, after completing each process of transmitting an integrated packet, the succeeding process of transmitting the next integrated packet begins instantly in response to the completion of the process of transmitting the integrated packet. For instance, in response to the completion of the process of transmitting a first integrated packet, the process of transmitting a second integrated packet instantly begins. Likewise, in response to the completion of the process of transmitting the second integrated packet, the process of transmitting a third integrated packet instantly begins, and so on. Accordingly, as shown in FIG. 6, the end of the integrated packet transmission period BOA of each integrated packet falls at the same point at the beginning of the integrated packet transmission period BOA of the succeeding integrated packet. Furthermore, as soon as the process of generating an integrated packet is completed, the generated integrated packet is instantly transmitted out.

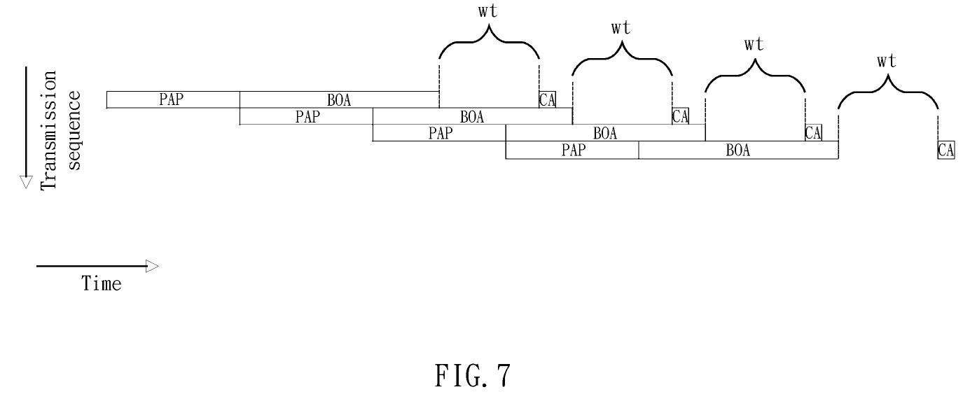

Please refer to FIG. 7, which is a time sequence diagram illustrating the USB bulk transmission according to the fourth embodiment of the present invention. The present embodiment is similar to the second embodiment, while the present embodiment differs from the second embodiment in that each packet transmitted during a period of time between two adjacent waiting periods is not simply a single packet but an integrated packet 20 shown in FIG. 5.

In the third embodiment, after completing the process of transmitting an integrated packet, the process of generating succeeding integrated packet is then correspondingly carried on. In the present embodiment, as soon as the process of generating any integrated packet is completed, the process of generating succeeding integrated packet correspondingly begins instantly. As shown in FIG. 7, after each integrated packet is generated, in order to correspond to the completing process of the integrating packet, the process of generating the succeeding integrated packet instantly begins. The process of transmitting the succeeding integrated packet is also executed right after being generated while each integrated packet is still transmitted. Therefore, compared with the third embodiment, the present embodiment provides higher efficiency of transmission rate.

Compared with the conventional methods, the method of the present invention for enhancing USB transmission rate continuously transmits the packets or integrated packets during the periods of time of waiting for the callback signals, thereby reducing unnecessary waiting time, and further increasing the data transmission amount during a time unit and increasing the data transmission rate. Therefore, the method of the present invention fulfills future demands on high transmission rate of Universal Serial Bus.

The foregoing descriptions of the detailed embodiments are only illustrated to disclose the features and functions of the present invention and not restrictive of the scope of the present invention. It should be understood to those skilled in the art that any modifications and variations according to the spirit and principle in the disclosure of the present invention should fall within the scope of the appended claims.

What is claimed is:

1. A method for enhancing Universal Serial Bus (USB) transmission rate, comprising the steps of:
generating a first packet;
transmitting the first packet;
producing a first callback signal corresponding to a receiving of the first packet by a recipient;
generating a second packet and then receiving the callback signal; and
transmitting the second packet.

2. The method of claim 1, wherein the step of transmitting the second packet begins in response to a completion of the step of transmitting the first packet.

3. The method of claim 1, wherein the step of generating the second packet begins in response to a completion of the step of generating the first packet.

4. The method of claim 1, wherein the step of transmitting the first packet begins in response to a completion of the step of generating the first packet, and the step of transmitting the second packet begins in response to a completion of the step of generating the second packet.

5. The method of claim 1, further comprising the steps of:
receiving a second callback signal, wherein the second callback signal is produced correspondingly to a receiving of the second packet by the recipient;
generating a third packet before receiving the second callback signal; and
transmitting the third packet.

6. The method of claim 5, wherein the step of transmitting the third packet begins in response to a completion of the step of transmitting the second packet.

7. The method of claim 5, wherein the step of generating the third packet begins in response to a completion of the step of generating the second packet.

8. The method of claim 5, wherein the step of transmitting the third packet begins in response to a completion of the step of generating the third packet.

9. A method for enhancing USB transmission rate comprising the steps of:
receiving a first plurality of packets, wherein each of the first plurality of packets comprises a header and a data string;
generating a first integrated packet according to the first plurality of packets, wherein the first integrated packet comprises all the data strings of the first plurality of packets but not any header of the plurality of packets;
transmitting the first integrated packet;
receiving a first callback signal, wherein the first callback signal is produced correspondingly to a receiving of the first integrated packet by a recipient;
receiving a second plurality of packets, wherein each of the second plurality of packets comprises a header and a data string;
generating a second integrated packet according to the second plurality of packets before receiving the first callback signal, wherein the second integrated packet comprises all data strings of the second plurality of packets but not any header of the second plurality of packets; and
transmitting the second integrated packet.

10. The method of claim 9, wherein the step of transmitting the second integrated packet begins in response to a completion of the step of transmitting the first integrated packet.

11. The method of claim 9, wherein the step of generating the second integrated packet begins in response to a completion of the step of generating the first integrated packet.

12. The method of claim 9, wherein the step of transmitting the first integrated packet begins in response to a completion of the step of generating the first integrated packet, and the step of transmitting the second integrated packet begins in response to a completion of the step of the generating the second integrated packet.

13. The method of claim 9, further comprising the steps of:
receiving a second callback signal, wherein the second callback signal is produced correspondingly to a receiving of the second integrated packet by the recipient;
receiving a third plurality of packets, each of the third plurality of packets comprises a header and a data string;
generating a third integrated packet according to the third plurality of packets before receiving the second callback signal, wherein the third integrated packet comprises all the data strings of the third plurality of packets but not any header of the third plurality of packets; and
transmitting the third integrated packet.

14. The method of claim 13, wherein the step of transmitting the third integrated packet begins in response to a completion of the step of transmitting the second integrated packet.

15. The method of claim 13, wherein the step of generating the third integrated packet begins in response to a completion of the step of generating the second integrated packet.

16. The method of claim 13, wherein the step of transmitting the third integrated packet begins in response to a completion of the step of generating the third integrated packet.
